(19) United States
(12) Patent Application Publication
(10) Pub. No.: US 2009/0044681 A1
(43) Pub. Date: Feb. 19, 2009

(54) MANUAL CERAMICS CUTTER

(76) Inventor: Josep Torrents I Comas, Barcelona (ES)

Correspondence Address: OSTROLENK FABER GERB & SOFFEN, 1180 AVENUE OF THE AMERICAS, NEW YORK, NY, 100368403, US

(21) Appl. No.: 12/294,719

(22) PCT Filed: Mar. 27, 2007
(86) PCT No.: PCT/ES2007/000164

§ 371 Date: Oct. 20, 2008

(30) Foreign Application Priority Data
Mar. 27, 2006 (ES) U200600738

(51) Int. Cl. B26D 3/08

(52) U.S. Cl. 83/886

(57) ABSTRACT

A cutter which includes a base, a longitudinal rail for the movable mounting of a handle carrying a blade or cutting tool, lateral folding arms and an orientable set square. The handle has rolling elements and an antifriction piece, for movement on the rail, a longitudinal guide for the interchangeable coupling of blade-holder pieces and a bolt for holding the blade-holder piece. The orientable set square is fixed at different angular positions by means of a bolt that is inserted in conical seats in a circular arrangement or by means of a vertical-thrust flange. The base comprises studs for the mounting of the folding arms with respective intermediate springs and tension-adjusting nuts.

### OBJECT OF THE INVENTION

A manual ceramics cutter, being of the type that has a base with an upper surface for the support of the piece to be cut, a longitudinal rail arranged in parallel and on top of the middle longitudinal area of the base, and a carrier handle for the cutting blade, moveable along said longitudinal rail.

### BACKGROUND TO THE INVENTION

Currently manual ceramics cutters are known that have two parallel guides for the moveable assembly of a handle with a foldable cutter holder, that can be activated manually, a cutting tool holder that has a circular blade which on being pressed and moved along a piece of ceramic marks a groove or scores a line on the surface for the breaking of the piece into two parts.

The ceramic cutters are also known that have a single central rail for the assembly of a mobile cutting tool handle, the ceramic cutter of this present invention belongs to this group of cutters.

In this type of cutter the circular blade, making up the cutting tool, is found to be mounted on a support bar that is fixed to the handle by means of a fixing nut. Therefore the assembly and replacement of the cutting tool requires the use of a screwdriver or suitable spanner to remove the stated fixing nut and then proceed once again with its placement, once having replaced the cutting tool. This operation is not convenient for the user, hence it is usual to use the same cutting blade to score different types of ceramics, when different blades should be used, and then continue to using the blade even when it is blunt, which can bring about faulty marking of the ceramic item and its irreversible damage.

Another disadvantage of this type of cutter is that both the track and equally the handle are made from metal, generally steel and aluminium respectively, which makes a noise from metal rubbing on metal and lack of comfort in use during the travel of the handle.

The metal nature of the handle and the track require the existence of sufficient play between both parts to allow the movement of the handle with the track; this play allows a certain amount of lateral rocking of the handle and consequently a certain irregularity of the cutting line of the ceramic piece.

In this type of cutter it is normal for the handle to have some separator feet on the lower part, placed on the handle itself, so as to exercise pressure on the parts of the ceramic piece placed on opposing sides of the scored line on said piece of ceramic by means of the cutting tool and then bringing about the breakage of the ceramic piece along said scored line.

Depending on the thickness of the pieces of ceramic to be cut these feet can be a nuisance or not be operational for dimensional problems.

The known ceramic cutters generally have an orientable set square on one end of the base for the lateral support of the ceramic piece to be cut with different angles compared to the longitudinal axis of the cutter.

In these known cutters this set square has a window by way of being a circumferential sector through which a screw fixed to the base of the cutter overlaps. A threaded screw or knob is fixed to said bolt which on being activated establishes the tightness against the base establishing its immobility. The activation of the bolt or knob against the surface of the set square, during the tightening of said screw can be brought about by friction, a certain turn of the set square, with the consequent angular gap of the set square compared to the required angular position and a lack of accuracy in the cutting angle or marking of the ceramic piece.

Some of the existing ceramic have some folding arms on the sides of the of the base, which can be left in a non-operational position, housed in the base of the cutter; or deployed towards the outside in order to increase the support surface of the piece of ceramic to be cut.

The folding arms in these cutters are assembled on a turning axis, with sufficient looseness to allow for its folding. It is normal for this looseness of the assembly to go on increasing with use, and that the folding arms, do not stay in a stable position in the required position, which ends up being especially inconvenient for the user.

One additional problem of the existing ceramic cutters is that they do not have sufficient housing to store the small necessary accessories such as the exchange blades, it being normal for these accessories to get lost or for the user not have said accessories when it is essential to use them, for example to make the scoring of a different type of ceramic.

### DESCRIPTION OF THE INVENTION

The manual ceramic cutter object of the present invention, has the following: a base, some upper appendixes, a central elevated track for the moveable assembly of a tool carrying handle, some folding arms for the additional support of the ceramic piece to be cut and an orientable set square for the side support of the ceramic piece to be cut, and having some construction peculiarities aimed at: eliminating the looseness of the assembly between the handle and the moveable track providing greater accuracy and regularity for the scoring or cutting line of the piece, allowing a smooth and silent movement of the handle along the carriage, and allowing cutting tool replacement to be carried out in a quick and easy manner, without the need to use any tools at all.

Another of the aims of the invention is the possibility of providing some folding separator feet to the handle so as to separate or break the ceramic piece along the marked line, eliminating the dimensional limitations posed by the separator feet defined on the handle of the cutter.

Other aims of the invention are: To allow the exact fixing of the set square in specific angular positions by means of a conical bolt that is inserted in some conical seats defined in the base, allowing for the locking of the set square in differing angular positions by means of a vertical thrust flange, that does not allow for unwanted lateral movements of the stated set square, guaranteeing the retention of the lateral arms in any angular position by means of the application of a permanent thrust against the base of the cutter, and providing the cutter with a specific housing for the safekeeping and transport of small accessories such as exchange blades.

In order to do this, and according to the invention, the handle has a longitudinal passage in which at least two bearings or roller elements are housed, facing the upper and lower surfaces of the longitudinal rail and at least one anti-friction piece fitted between the side surfaces of said passage and the longitudinal rail. The mentioned anti-friction piece or pieces can be made from plastic or any other material that allows an adjustment of the handle assembly to be made in regard to the rail preventing unnecessary looseness and providing a smooth and silent movement of the handle along the rail.

The bearings or roller elements fitted on the inside of the longitudinal passage are kept at a distance that has a length that is greater than the height of the longitudinal rail, which allows for the inclination of the handle towards the front or back and being in an operational cutting position or in a non-operational position.

At the lower end of the handle there is a longitudinal guide for the interchangeable attachment of the of the blade holder pieces that have a slot to enable them to be held in an assembly position as will be described below. Clearly the longitudinal guide of the handle and the blade holder pieces have similar and suitable sections to enable their coupling in a single position and without being able to turn sideways.

In the lower part the handle has a transversal housing into which a retaining bolt is fitted for the blade holder part. Said bolt can be moved manually and without any tools at all, from an operating position, in which the it is partially housed in the groove of the blade holder part establishing its fixing, and a non-operating position in which the blade holder piece is free allowing for the dismantling of the handle. In this way, the replacement of the blade holder pieces for another that is more suitable or in a better condition can be carried out in a quick, easy and convenient manner.

The stated retention bolt meets a thrust spring that holds it in the operating position or that for the fixing of the blade holder piece. When the user stops manually activating the retention bolt, after having placed or replaced the blade holder piece, the stated spring is in charge of returning the bolt of the blade holder piece to its blocked position and keeping it in said blocked position.

The stated retaining bolt has a lateral rabbet, facing the assembly guide of the blade holder piece, said lateral rabbet having a length that is greater than the width of the stated assembly guide. The definition of this rabbet in the retention bolt enables its position in the blocked position and the release of the blade holder piece, without the need to dismantle the handle, in this preventing its loss.

According to the invention, the handle can be have a folding piece that has some separator feet and an activation arm arranged in appreciably perpendicular planes, said piece being assembled on the handle by means of a turning axis and the possibility of folding between a working position, in which said separator feet are held appreciably in a vertical position, aimed towards the lower part, and a non-operational position in which said separator feet are in an appreciably horizontal position.

In combination with this folding piece, the cutter has an adjustable stop assembled on the rail by means of a pressure element and that maintains the path described by the activation arm in the operating position of the folding piece.

The purpose of this stop is to allow the return of the folding piece to the non-operational position, after having been used to separate a piece of ceramic that has previously been marked with the blade, without it being necessary for the user having to bend it manually. When the folding part where the separator feet are fitted is in the operational position, it is sufficient for the user to move the handle towards the end of the rail where the stop is fitted so that the folding part is placed into a non-operational position, as when the activating arm of the folding piece comes into contact with the fixed stop, this fixed stop brings about the folding towards the stated non-operational position.

According to the invention, at one of the ends of the upper part of the cutter base there are a series of conical seats, arranged in a circular position, for the optional housing of a conical bolt fitted onto an orientable set square with the possibility of vertical movement. These conical seats are arranged, in regard to the transversal axis of the cutter, in the most normal angular positions, for example forming angles of 0, 15, 30 and 45 degrees.

The introduction of the conical point of the bolt into any of the conical seats of the base, determines the exact position of the set square with the chosen angle.

Additionally, the cutter has a vertical thrust flange facing the upper surface of the orientable set square. Said flange can immobilise the orientable set square in any of the angular positions that the said orientable set square can achieve.

Said vertical thrust flange has: an activating lever that has an adjustable height pusher on the front fitted with a layer of an elastic material on the end facing the upper surface of the folding set square and an actioning lever for the activation lever between an operational position, in which said actioning lever presses vertically on the folding set square against the base and a non-operational position in which said actioning lever is kept at a vertical distance from the folding set square.

The vertical action of the actioning lever, by means of a layer of elastic material, onto the folding set square, prevents unwanted angular movements of the folding set square.

According to the invention, the actioning lever and the manual lever are assembled on one of the upper appendixes of the base.

The base of the cutter has a specific housing for accessories, such as cutting blades, in such a way that they can be transported together with the cutter and be kept available for use. Said housing can be fitted with closure lid.

Additionally, on each one of the sides the cutter base has a vertical pivot, joined to the base and orientable towards the lower part, the following being correlatively assembled on said vertical pivot: a folding arm for the additional support of the ceramic piece to be cut, an intermediary spring and an adjustable bolt for the tension of the intermediary bolt.

The regulating bolt allows the adjustment of spring tension to be made and guarantees that the spring pushes the folding arm against the base, in such a way that said folding arm can be fitted in a stable manner in the operative and operating positions.

### DESCRIPTION OF THE FIGURES

In order to complete the description that is being made and for the purpose of providing a better understanding of its characteristics, a set of drawings is attached to this present description in which the figures being by way of illustration and are not by way of limitation on the invention, in which the following is shown:

FIG. 1 shows a perspective view of an example of an embodiment of the manual ceramic cutter.

FIG. 2 shows an elevation outline view of an example of an embodiment of the manual ceramic cutter.

FIG. 3 shows a top plan outline view of the cutter as shown in the previous figure.

FIG. 4 shows a partial perspective view of the handle assembled on the longitudinal rail, in which a dismantled blade holder piece is shown and aligned with the lower handle guide.

FIG. 5 shows a front view of the handle assembled on the longitudinal rail and partially sectioned, in which the blade holder retaining piece can be seen in the unlocked position.

FIG. 6 shows a similar view to the previous view with the retaining piece of the blade holder piece in the locked position.

FIG. 7 shows a partial elevation view of the cutter with the handle in the position of use, with one being able to see the blade incising the ceramic piece positioned on the base.

FIG. 8 shows a partial view of the handle in the same position as FIG. 7 and sectioned along a vertical plane.

FIG. 9 shows a partial elevation view of the cutter during the separation or breakage of the ceramic piece by means of the separator feet; in this figure the separator feet have been show as a dotted line in their non-operating position and with an unbroken line for the entirety of the folding piece in the operational position.

FIG. 10 shows a partial elevation view of the cutter with the folding piece in the operating position and during the movement of the handle towards the end of the stop carrier rail that is for the return of the folding piece to the non-operating position.

FIG. 11 shows a detail in elevation of the arm during the return of the folding piece to the non-operating position due to the action of the stop against the arm of the folding piece.

FIG. 12 shows an outline elevation and partially sectioned view of one of the ends of the cutter in which the thrust flange of the orientable set square can be seen in a locked position.

FIG. 13 shows an elevation detail of the retention pin of the set square with the conical point housed in one of the conical seats placed in the base of the cutter.

FIG. 14 shows an elevation view of an intermediary part of the base in which the assembly pivot of the corresponding folding arm can be seen, also the spring and the turn screw.

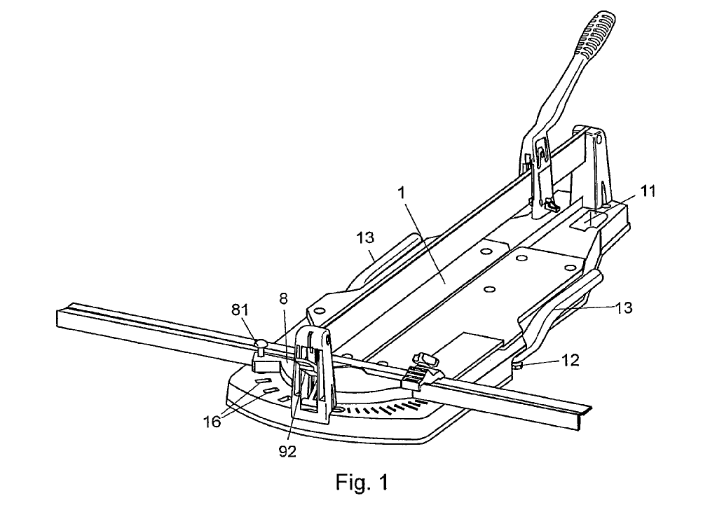

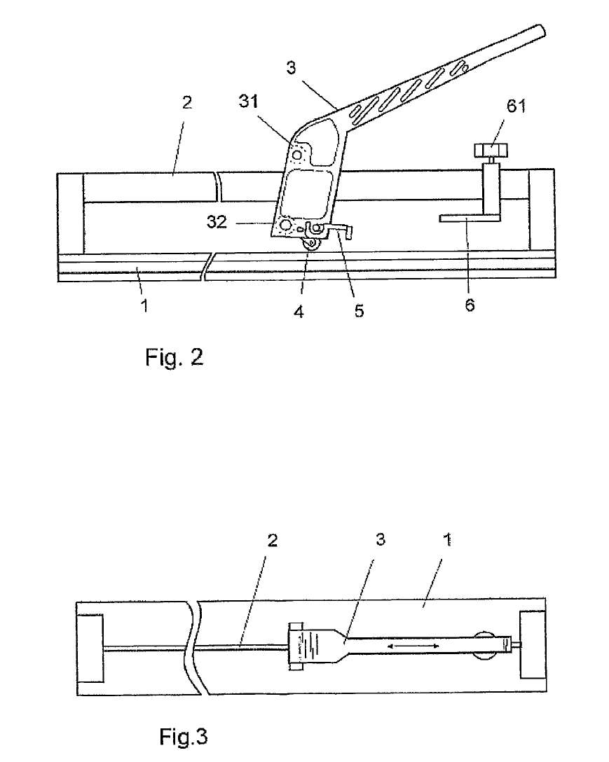

### PREFERRED EMBODIMENT OF THE INVENTION

In the example of the embodiment shown in the attached figures, the ceramic blade or disc cutter (4) has a base (1) that has some upper appendages onto which a longitudinal rail (2) is assembled for the movement of handle (3) carrying and a folding piece (5) for the pressing and separation of the ceramic pieces (7) along the line produced by means of the blade (4).

The handle (3) has a longitudinal passage in which an upper bearing (31), a lower bearing (32) and side pieces (33) are housed which are respectively facing the upper, lower and side surfaces of the rail (2). On the bottom the handle (3) has a longitudinal guide (34) for the inter-changeable coupling of the blade holder pieces (41).

Said blade holder pieces (41) have a transversal groove (42) to lock into the operating position by the retaining nut (35) assembled in the transversal housing of the handle (1).

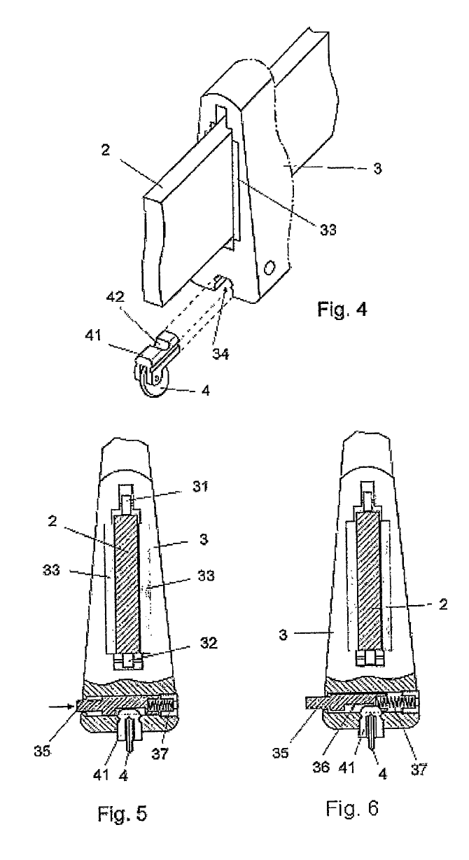

The retaining nut (35) has a lateral rabbet (36) against the assembly guide (34) of the blade holder piece (41) and is moved towards the retaining or locked position, shown in FIG. 5, by the action of the spring (37). When the retaining nut (35) is manually moved overcoming the resistance of the spring (37) the lateral rabbet (36) of said nut comes against the guide (34), as shown in FIG. 4, allowing for the dismantling of the blade holder piece (41).

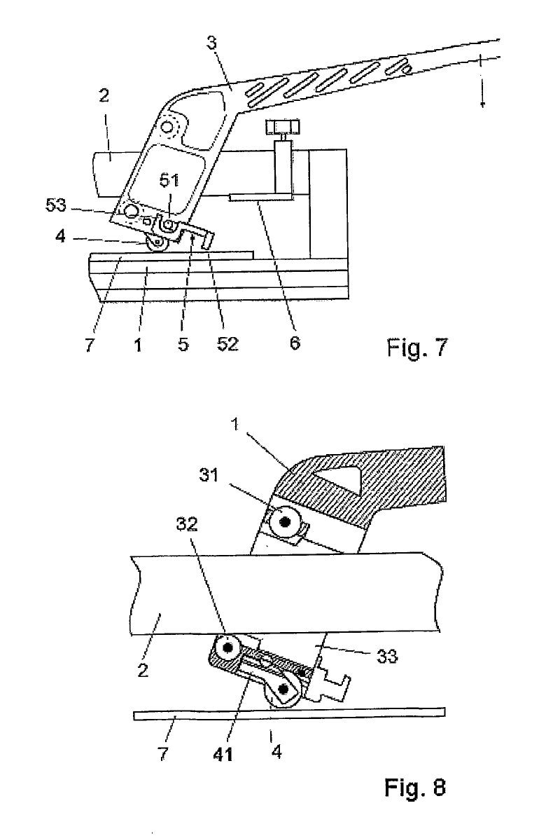

The folding piece (5) is assembled on one of the lower ends of the handle (3) by means of the axis (51) that allows for the application of pressure on the ceramic piece (7), as shown in FIG. 8, to bring about the break along the scored line that was previously produced on said piece by means of the pressure and movement of the blade (4) as and how shown in FIGS. 6 and 7.

The folding piece (5) has some separator feet (52) that are to place pressure on the ceramic piece (7) to bring about the break or separation along the scored line, and an actioning arm (53).

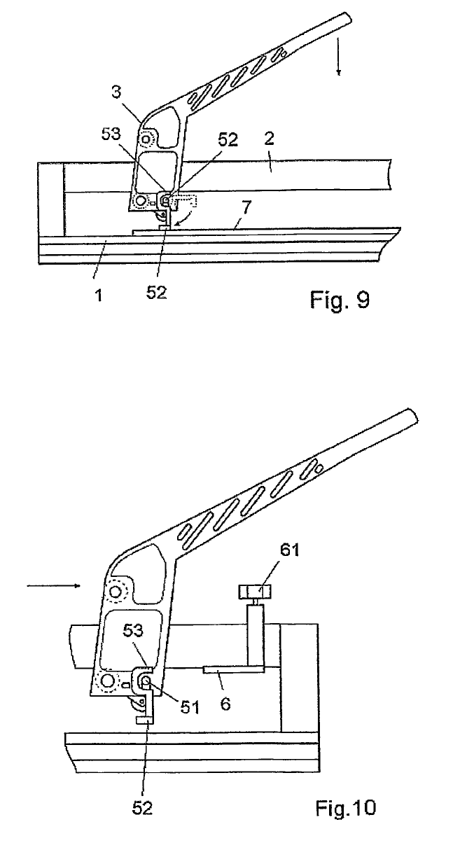

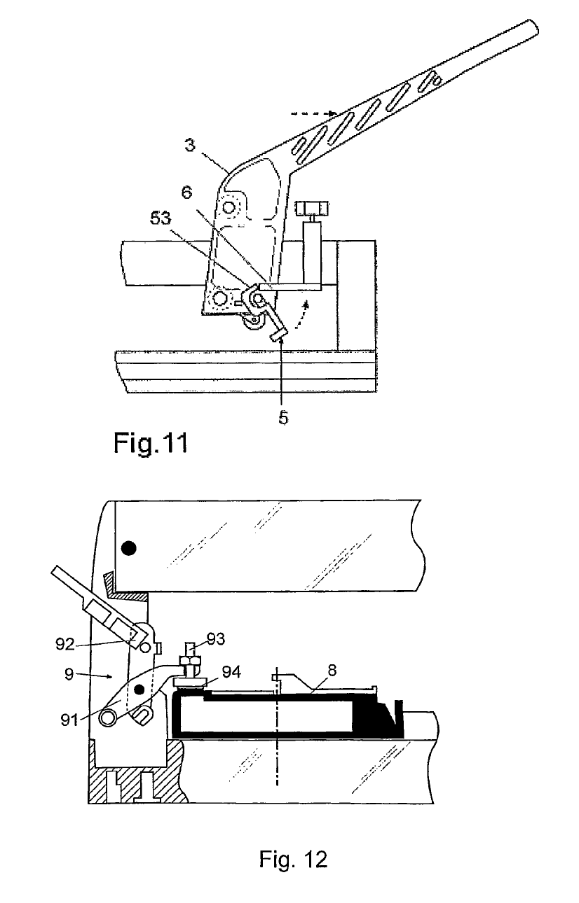

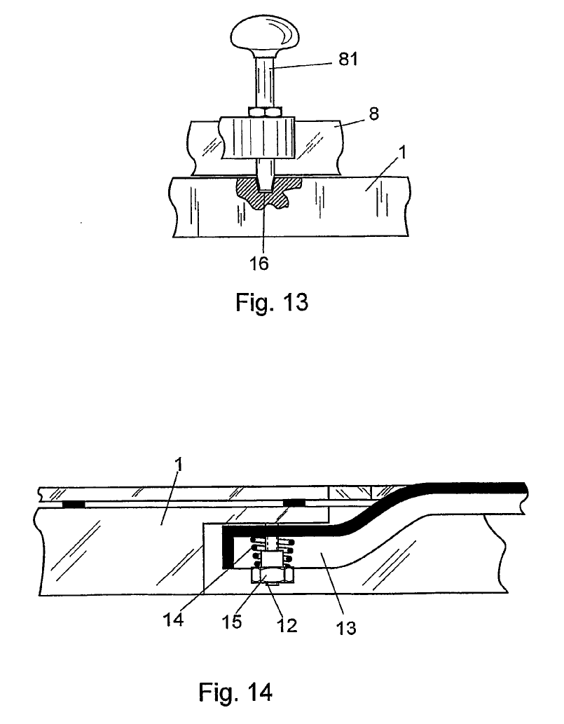

The folding piece (5) must be placed manually in the operational position, this means with the separator feet (52) angled towards the lower part, returning to the operational position when the user moves the handle (3) towards one of the ends of the rail (2) and the actioning arm (53) comes up against a stop (6) that is fixed onto the stated rail (2) by a pressure element or screw (61) as and how shown in FIGS. 9 and 10.

As can be observed in FIG. 7 the distance between the rollers (31 and 32) is greater than the height of the rail (2), which allows the handle (3) to swing towards the forward and rear zones in order to place it in different operating positions for marking and to separate the ceramic piece (7).

The base (1) has a housing (11) to hold the differing accessories, such as exchange cutting blades.

Said base has respective pivots (12) on its sides, with the following being correlatively assembled onto each one of the pivots (12); a folding arm (13) for the additional support of the ceramic piece to be cut, an helical spring (14) and a bolt (15) for the regulation of the tension of the spring (14).

Said spring (14) presses the folding arm (13) against the surface of the base (1), allowing its fold into the operating and non-operating positions, and guaranteeing the stable retention of said folding arm (13) in any of the stated positions.

There is an orientable set square (8) assembled on one end of the base (1) with the possibility of a horizontal turn, which is used for lateral support of the ceramic piece to be cut.

The orientable set square (8) is fitted with a conical pointed bolt (81), enabling its vertical movement, so as to lock the set square in different angular positions, set by some conical seats (16) arranged in a circular manner and defined on the base (1).

The introduction of the conical point (81) of the bolt in any of the seats guarantees the retention of the orientable set square (8) in a specific angular position.

Additionally, the cutter has a vertical thrust flange (9) to retain the set square in any possible angular position.

Said flange (9) has a set of levers, made up of an actioning lever (91) and an activating lever (92) for said actioning lever.

The actioning lever (91) has an adjustable height pusher on the front end that has an elastic material layer (94) on the upper facing surface of the orientable set square (8) that will make the turn of the orientable set square (8) impossible by the action of the actioning lever.

The activating lever (92) overlaps the rear area of one of the upper appendages of the base and allows the actioning lever (91) to be used in the operating position, said actioning lever presses vertically on the orientable set square (8) against the base preventing it from turning, or in a non-operating position in which said actioning lever (91) is vertically distanced from the orientable set square, allowing it to turn or reposition at an angle.

Once having sufficiently described the nature of the invention, likewise having given a preferred embodiment it is placed on record that the materials, shape, size and arrangement of the elements described can be modified provided that they do not mean an alteration of the basic essentials of the invention that are claimed below.

1. A manual ceramic cutter of the type that includes a base with an upper surface for the support of the ceramic piece to be cut, a longitudinal rail arranged parallel and on top of the middle longitudinal area of the base and a handle carrying a cutting blade or tool holder, that is moveable along said longitudinal rail; wherein the handle has a longitudinal passage in which at least two bearings or rolling elements are in front of the upper and lower surfaces of the longitudinal rail and at least one piece of anti-friction material placed between the opposing side surfaces of said passage and the longitudinal rail; wherein the handle has a longitudinal guide on its lower end for the interchangeable fitting of blade holder pieces which has a transversal groove, and in that the handle has a transversal housing on its lower part into which a retaining bolt is fitted with the possibility of manual movement between an operating position, in which the groove of the blade holder piece is partially housed, establishing its fixation to the handle, and a non-operating position in which the blade holder piece is released allowing the handle to be dismantled.

2. The cutter according to claim 1, wherein the bearings or roller elements are along the longitude at a greater distance than the height of the longitudinal rail.

3. The cutter according to claim 1, wherein the retention bolt meets a thrust spring, that holds it in the operating position or that for the fixing of the blade holder piece.

4. The cutter according to claim 1, wherein the retaining bolt has a lateral rabbet, meeting the longitudinal guide assembly of the blade holder piece, said lateral rabbet having a length that is greater than the width of the stated longitudinal guide.

5. The cutter according to claim 1, wherein the handle has a folding piece that has some separator feet and an actioning arm arranged in appreciably perpendicular planes, said folding piece being assembled on the handle by means of a turning axis and with the possibility of being able to fold from a working position in which the separator feet are arranged vertically, angled downwards, and a non-operating position in which said separator feet are appreciably horizontal.

6. The cutter according to claim 5, wherein it has an adjustable stop assembled on the rail by means of a pressure element and fitted in the path described by the actioning arm in the operating position of the folding piece.

7. The cutter according to claim 1, wherein the base at one of their ends of the upper part has a series of conical seats, arranged in a circular position, for the optional housing of a conical bolt fitted onto an orientable set square with the possibility of vertical movement.

8. The cutter according to claim 7, wherein it has a vertical thrust flange against the upper surface of the orientable set square.

9. The cutter according to claim 8, wherein the flange has: an activating lever that has an adjustable height pusher on the front fitted with a layer of an elastic material on the end facing the upper surface of the folding set square; and an actioning lever for the activation lever between an operational position, in which said actioning lever presses vertically on the folding set square against the base and a non-operational position in which said actioning lever is kept at a vertical distance from the folding set square.

10. A cutter according to claim 1, wherein the base of the cutter has a housing that is specifically for accessories.

11. The cutter according to claim 1, wherein on each side of the base there is a vertical pivot, joined to the base and angled downwards to the lower part, with the following being correlatively assembled on said vertical pivot: a folding arm for the additional support of the ceramic piece to be cut, an intermediary spring and an adjustable bolt for the regulation of the tension of the spring.
